(19) United States
(12) Patent Application Publication
(10) Pub. No.: US 2026/0276428 A1
(43) Pub. Date: Sep. 17, 2026

(54) LIQUID LEVEL METERING USING INDUCTIVE TECHNOLOGY

(71) Applicant: AZOTEQ HOLDINGS LIMITED, Nicosia (CY)

(72) Inventors: Daniel Barend RADEMEYER, Paarl (ZA); Wikus WOLMARANS, Paarl (ZA); Frederick Johannes BRUWER, Paarl (ZA); Frederick Johannes BRUWER, JR., Paarl (ZA); Francois BRUWER, Paarl (ZA)

(21) Appl. No.: 19/565,949

(22) Filed: Mar. 13, 2026

(30) Foreign Application Priority Data
Mar. 13, 2025 (ZA) 2025/02231
May 14, 2025 (ZA) 2025/04072

(51) Int. Cl. G01F 23/72

(52) U.S. Cl. CPC G01F 23/72

(57) ABSTRACT

A sensing system senses a position of an object along a sensing axis, and has a plurality of sensing coils arranged along the sensing axis. A plurality of sensing coils are positioned on a first side of a covering member, and an object is positioned on a second side thereof. Measurement circuitry is coupled to the sensing coils and is configured to measure a change of inductance of the sensing coils that is caused by an interfering member, having an interfering magnetic field, adjacent to the object, The measurement circuitry is further configured to determine the position of the object along the sensing axis based on the inductance change caused by the interfering magnetic field of the interfering member as part of the object. The interfering member may be a magnet, a passive LC circuit, a metallic interfering member or a highly permeable material such as ferrite.

### CROSS-REFERENCE TO RELATED APPLICATION

The present application claims priority from South Africa applications ZA 2025/02231, filed Mar. 13, 2025, and ZA 2025/04072, filed May 14, 2025, contents of which are hereby incorporated by reference into this application.

### BACKGROUND OF THE INVENTION

Determining levels of fluid (e.g. water, fuel, brake fluid, detergent, oil, milk) in engines, appliances, vehicles and other products is important. Many prior art and state of the art fluid level meters make use of magnets, for example, in a float that activates successive Reed relays as the float passes relays thereby forming a digital signal upon the closing of each relay. Another prior art structure uses an inductor that is wound in such a way that the winding density varies along the axis of measurement. The latter structure has an interfering member that affects the inductance of the inductor based on where the interfering member is positioned (e.g. as part of a float). In this case it is important to have an absolute and accurate reading, since any change due to environmental effects will affect the fluid level measurement. It can be said that some Reed relay approaches are digital and robust but are restricted in respect of information delivery and the aforementioned inductive measurement system is analog but can produce variations in fluid level measurements, and is complex to configure. It is an objective of this invention to improve upon the former and the latter state-of-the-art designs.

Another challenge when electing to use inductive measurements for level metering is the fact that many containers and liquid holders are furnished from metallic materials, such as steel, iron, copper, aluminum and many different alloys. These materials are typically electrically conductive, which means that any inductive sensing method used must be done at lower frequencies (typically below 50 kHz) to ensure that magnetic fields sufficiently penetrate the metallic container and to minimize eddy-current losses. However, operating the inductive sensor at lower frequencies may lead to higher power consumption. Thus, it is an objective of the current invention to provide a sensing system and method to perform high frequency inductive measurements to detect objects (such as a float device in liquid) through metallic objects without eddy current losses.

### SUMMARY OF THE INVENTION

This invention describes the implementation of a sensing system to determine the position of an object along a sensing axis. A good practical use is level metering using inductors. A preferred inductive measurement technique used is resonant LC tank-type sensing wherein a specialized float member (or the detected object in more general terms) in the liquid may be used to affect the impedance of each LC tank coil sensor. Said sensors may be measured with a measurement circuitry such as an integrated circuit (IC) device, or any device capable of measuring a parameter of an inductor, as would be obvious for one skilled in the art. Said float object may comprise an interfering member to affect the impedance of each LC tank sensor. Examples of interfering members include highly magnetically permeable members (e.g. ferrite), electrically conductive members (e.g. copper or aluminum), short-circuit coil circuits, passive LC-tank circuits, permanent magnets or polarized magnets in general.

Reference to water herein is exemplary and not restrictive, since the inventive principles can be used with any liquid. The inductors can be formed in many ways in order to suit the specific application. Several examples will be described but these should not be viewed as exhaustive since other inductor configurations and designs can be used in accordance with this invention. Also, any reference to ‘LC’ in context of LC tank or LC circuit may also be interpreted as being an RLC system as well, since the resistive component is automatically included simply by the wiring of the LC circuit, and a discrete resistor component may optionally be included in the LC circuit if necessary.

The invention describes a sensing system for sensing the position of an object (such as a liquid float) along a sensing axis and through a covering member (i.e. sensing through a tank wall or enclosure that separates the sensors from the object). The aim of the sensing axis as referenced throughout the invention is simply to define the direction of position sensing, and is not necessarily the center axis of movement for an interfering member. For example, a sensing axis may be indicated as a vertical line in an embodiment, which indicates that an interfering object may move along it by having the sensing axis as the center axis of movement, or parallel to the sensing axis (thus being offset from the sensing axis).

In a first embodiment, a sensing system is disclosed comprising a sealed non-electrically conductive tube (e.g. glass, plastic may be used) extends either from the bottom to the top of a tank (i.e. a liquid holder) or from the top to near the bottom of the liquid holder. This tube is sealed where it is attached to the top or bottom to prevent leaks from the tank, and to prevent liquid from entering the tube's structure. The tube and float need not be circular, but for the purpose of the description will be described as circular in outline e.g. annular and fitted around the tube to move up or down with the fluid level.

In this first embodiment, the sensing system may comprise multiple coils (e.g. air coils) formed with wires that are positioned over the length (parallel to a sensing axis) of the tube on an inner side, at defined distances apart. The coils can be placed on or around a printed circuit board (PCB) that is inserted into the tube with the sensing coils formed close to an inner wall surface of the tube or wires can be formed around a template structure protruding into the tube and connections to each inductor are brought out of the tube. Each sensing coil forming an inductor can be paired with a capacitor (C) to form an LC resonant tank. Optionally, resistive components may be added to the LC circuit making it an RLC circuit, for the purposes of altering the sensing coil's response to the presence of an interfering member.

These resonant tanks (or inductors) are linked to an measurement circuit that effectively measures the change of inductance or, more generally, the change of impedance of each sensing coil. The measurement circuitry can be in the tube or form a part of electronics outside the liquid holder.

A float that comprises material that can reliably operate in the specific fluid must be chosen and positioned around the tube. Obviously, the float must be less dense than the liquid in order to be a float. On the inside of the float near the inner diameter of the float an interfering member with an interfering magnetic field may be placed. Said interfering magnetic field may be inherent to the interfering member (for example a permanent magnet), or may be induced because of its proximity to the sensing coils (for example the magnetic field due to eddy currents on a metal target, or the magnetic field induced in a passive LC circuit target). This interfering member can be fully sealed inside the float housing and does not need to be exposed to the liquid.

A first example of an interfering member is an electrically conductive metal band or ring, for example aluminum, copper etc. The width of the band is chosen in relation to the separation distances between the coils inside the tube, for example, to affect at least one or two coils at any time. The objective is to be able to identify the coil mostly affected by the interfering member. One may also derive data from differential measurements with another neighboring coil or coils in order to offer more detailed level measurement information than to be limited to only the number of coils.

In a second example of an interfering member a solenoid coil that is shorted together at two ends is positioned inside the float or attached to the float. The length of the coil is similarly chosen as per the metal band. The effect of this coil moving as part of the float along the tube and covering/overlapping with the various coils inside the tube is very similar to the effect of the metal band in the first example.

In a third example the interfering member inside the float comprises a resonant tank i.e. an LC combination that is resonant at the same frequency at which the LC-tank sensing coils inside the tube is driven. Although totally passive (only R, L and C), this configuration yields a much more pronounced effect on the measured inductance or impedance of the inductors inside the tube when it moves closer and over the inside sensing coils, leading to better signal strength for detecting the interfering member and better signal-to-noise (SNR) ratios. The improved SNR allows for more distance between the float (containing the interfering member) and the sensing coils inside the tube, or at the same distance gives more resolution in level indications.

In another embodiment a PCB can be used that comprises planar inductor sensing coils with tank capacitors to tune the frequency of the oscillating tank in accordance with the inductance for an LC resonant tank. The inductor can be formed on a single side or by using multiple PCB layers in order to increase the inductance per area. An interfering member (similar to the three examples above) may be formed in the shape of a flat circular disc (similar shape to a coin). As the disc moves over the PCB inductor it will influence the inductance and the change is detected by using a measurement IC, which may further comprise additional measurement circuitry connected to the IC and to the sensing inductor. The measurement can be performed by measuring changes in frequency, impedance, voltage, current, charge stored and discharged as a result of the magnetic field in the sensing inductor, or pure inductance measurement techniques.

In accordance with this invention the PCB with the planar inductive coils may be placed flat against a wall of the tube or vessel containing the fluid that must be measured. The aforementioned disc may be formed as part of a float member that is positioned inside the vessel and moves up and down with the fluid level. A guiding structure may keep it proximate to the PCB. As the float member comprising the disc interfering member moves over the sensing coils (although sealed off) it affects the measured parameters of the sensing coils on the PCB which in turn enables the determination of the fluid level, and other variables such as liquid turbulence and liquid leakage into the container where the sensing coils are located. A ferrite layer may be placed over on the non-sensing side of the PCB to protect the sensing coils from rear-side interference.

In another embodiment the coils (similar to the first embodiment described above) are formed on the PCB itself using multiple layers and vias (pathways) between the layers, which may also be referred to as stitched coils. The PCB can still be inserted into a circular tube but the tube may alternatively be rectangular. The float still moves up and down the outside of the tube and the interfering member inside the float still affects the measured parameters of the sensing inductors on the PCB inside the tube.

With the right spacing of the sensing coils (i.e. measuring inductors) and the appropriate size of the interfering member, differential measurements may be performed to provide more accurate resolution of the fluid level. For example, if the interfering member is designed to affect only two inductors at any position, then all the advantages of the digital prior art systems are offered. It will be clear from the measured data which coil is most affected by the interfering member. That is the digital part. If two coils are equally affected the level is perfectly in the middle of the two inductors and this can be reported to a user interface device, such as a computer, controller or other indication device such as a digital display using a wired or wireless connection.

As the float moves further from one inductor and closer to covering another inductor, numerous liquid level increments or decrements of small magnitude can be determined from using a delta profile between the neighboring coils, or by using differential measurements. Additionally, since environmental effects (e.g. temperature) will affect both measurements equally the accuracy will remain good. In another embodiment the interfering member can be designed to affect three (or more) inductors at the same time, i.e. it will always be fully covering at least one sensing coil and the differential measurement on the two neighboring sensing coils may then be used to determine an analog-type level with more resolution.

In another embodiment, the fluid is inside a tube (sighting pipe) external to a liquid container. The tube may be made of a non-electrically conductive material, and a float is positioned in the fluid within the tube, that is, the float will always be at or near the very top of the fluid inside the tube. In this embodiment the inductor coils are wound around the sighting tube at predetermined distances apart. The interfering member inside the float is proposed to be either a passive resonant LC tank circuit or purely a ferrite rod embedded inside the float. The concept is the same in terms of handling the measurements from the various sensing inductors and determining the level of fluid.

The embodiments described thus far require the tank or tube wall to be made of a non-metallic material, or at least a material that is not electrically conductive. However, many containers are made of various types of metals. To this end, a novel sensing solution is presented for performing high-frequency (greater than 50 kHz) inductive sensing through a covering member that is metallic (such as a metal tank wall) to detect the presence of an interfering member. In this embodiment, the interfering member is a permanent magnet and its interfering magnetic field is the magnetic field inherent to the magnet, and the magnet may be contained within the float member. On the non-liquid side of the tank wall, a PCB with a plurality of sensing coils may be positioned against or nearly against the surface of the metal tank wall. Additionally, a ferrite sheet or separate ferrite sheets may be placed on top of the sensing coils thereby separating the sensing coils from the metal tank wall. In this embodiment, the interfering magnetic field emitted by the magnet interferes with the ferrite layer's properties. This has a double effect: The ferrite's properties are altered such that it loses a great deal of its permeability, which reduces the inductance of the sensing coil in the region of the magnet in a measurable manner. At the same time, there is a second effect wherein the sensing coil is now effectively exposed to the metal tank wall (due to the saturated ferrite layer) that now forms Eddy current losses to further suppress the inductance of the sensing coil. This double effect leads to substantial signal levels for detecting the float member using high frequency sensing coils, with a high SNR.

In alternative embodiment, the aforementioned embodiment's benefits of high SNR may be achieved in a setup where the tank wall is not metallic. In this case, a metallic layer such as copper tape may be added on top of the ferrite layer, which will lead to the same effect.

### BRIEF DESCRIPTION OF THE DRAWINGS

The invention is further described by way of examples with reference to the accompanying drawings in which:

FIG. 1a shows a sealed tube with inductors and a liquid float with an interfering member.

FIG. 1b is a side sectional view of sensing coils around a PCB with a metal band interfering member;

FIG. 2a shows a metal band interfering member;

FIG. 2b shows a shorted inductor interfering member;

FIG. 2c shows a passive resonated RLC tank circuit interfering member;

FIG. 3a shows planar sensor coil inductors on a printed circuit board;

FIG. 3b shows a float object with a passive LC circuit as an interfering member;

FIG. 4a is a top sectional view of planar sensing coils on PCB with a float object;

FIG. 4b shows a side view of a disk-shaped interfering member on the side of a container;

FIG. 5 shows a stitched sensing coil configuration for position sensing along a sensing axis;

FIG. 6 is a sectional top-down view of the placement of a sensing coil PCB within a tube;

FIG. 7 shows a float on the inside of a tube with electronics and inductors on the outside of the tube;

FIG. 8 shows an impedance response versus the frequency of sensing coils;

FIG. 9 shows typical measurement signals of sensing coils;

FIG. 10a shows an interfering member with a polarized magnet;

FIG. 10b shows a ring magnet as an interfering member for a wound sensing coil; and

FIG. 11 shows an exemplary method for determining the position of an object using the sensing coils.

### DETAILED DESCRIPTION OF THE INVENTION

The description that follows is aimed at clarifying the methods and implementations in accordance with this invention in an exemplary manner and it is not meant to be exhaustive or limiting

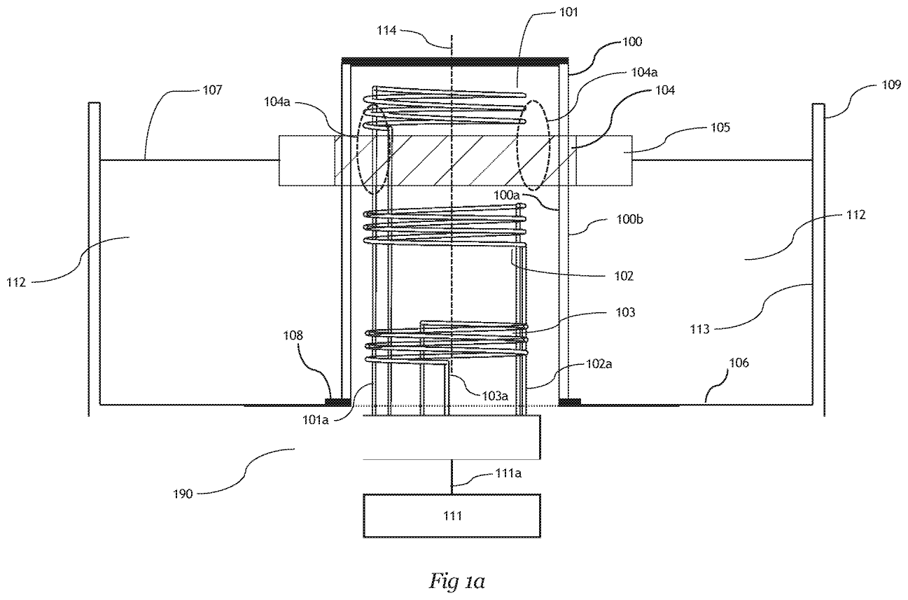

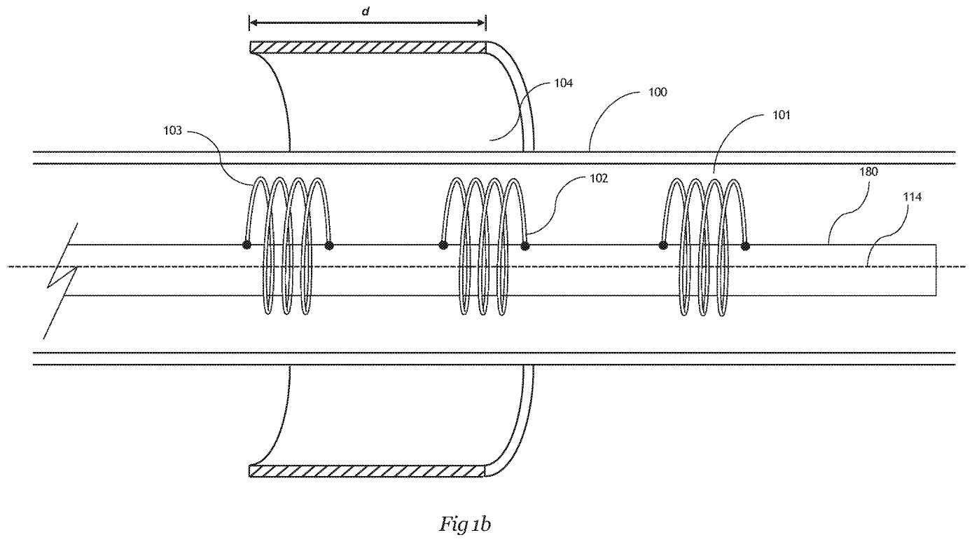

In FIG. 1a, a non-electrically conducting or non-metallic covering member 100 (or a tube 100) is shown that is positioned on a bottom surface 106 of a container 109 holding a liquid or fluid volume 112. The tube 100 may be made of, for example, different kinds of plastics including but not limited to high-density polyethylene (HDPE), low-density polyethylene (LDPE), polyethylene terephthalate (PET), polypropylene (PP), polyvinyl chloride (PVC) or any combination thereof. Alternatively, materials such as glass, ceramic, silicone, paperboard or cardboard that is coated, bioplastics, etc. may be used. While FIG. 1a illustrates tube 100 to be circular, those skilled in the art shall appreciate that tube 100 may also be square, rectangular, oval, or any shape necessary to fit the application as best possible. The width of tube 100, although somewhat narrower than container 109, is not restricted. In a preferred embodiment, tube 100 is filled with air, and air-tight sealed against the liquid volume 112 in container 109. Said seal may be accomplished by a seal 108 at a bottom surface. While air is preferred, any other inert filling may be used for tube 100.

The material of container 109 may be the same as or different from that of the tube 100. Furthermore, tube 100 and container 109 may be molded to be one piece instead of two pieces attached by means of a seal 108.

FIG. 1a shows that seal 108 is situated against the bottom surface 106 of container 109, however this shall not be construed as the only position of seal 108. Tube 100 may also be sealed off by a seal 108 against a top surface (not shown) if container 109 is a closed container. Alternatively, those skilled in the art shall appreciate that it is possible to design tube 100 to seal against the inner surface of side wall 113 of container 109 instead. Different types of seal materials for seal 108 may be used, including but not limited to elastomers such as silicone rubber, polytetrafluoroethylene (PTFE) and similar for chemical resistant applications, silicone, epoxy, and the like. The liquid body 112 therefore surrounds the tube 100 but below the bottom wall 106 and inside the tube 100 there is no fluid.

On a first inner side 100a of tube 100, three sensing inductors/coils 101, 102 and 103 are shown but this can be any number as per the application requirement. Electrical connections 101a, 102a and 103a from each coil come out from the tube 100 and may be connected to measurement circuitry 110. Said measurement circuitry may then be further connected to a user interface system 111. Examples of measurement circuitry may include an integrated circuit (IC) device, master controller unit (MCU) device or any electrical circuit or processor that is able to measure an electrical characteristic relating to sensing coils 101, 102 and 103. Measurement circuitry may include other passive electrical components such as resistors, capacitors and even inductors to aid in the measurement of the electrical characteristic of coils 101, 102 and 103. Said electrical characteristics may include one or any combination of the following:
Voltages relating to sensing coils 101, 102 and 103;
Electrical current relating to sensing coils 101, 102 and 103;
Magnetic energy stored or discharged by sensing coils 101, 102 and 103;
Electrical energy/electrical charge stored or discharged relating to sensing coils 101, 102 and 103;
Impedance of sensing coils 101, 102 and 103;
Resonant frequency relating to sensing coils 101, 102 and 103;

In the cases where this specification refers to ‘the measurement of a change in inductance of sensing coils’, it may also be interpreted as the measurement of any one of the aforementioned electrical characteristics of the sensing coils.

Examples of user interface systems 111 or devices include screens, LEDs, mobile devices, computers, and the like. The connection 111a may be wired or wireless, the latter being for example, Bluetooth®, Wifi, Zigbee®, and so on.

In one embodiment, sensing coils 101, 102 and 103 are each part of a respective LC-tank resonant circuit connected to circuitry 110. An interfering member 104 having an interfering magnet field 104a (said field 104a being induced by the sensing coils 101, 102 and 103) may be attached to a float 105 which is positioned on an outer side 100b of tube 100, and when member 104 overlaps with one or more of the sensing coils 101, 102 or 103, the resonant frequency of the LC-tank of which the overlapped sensing inductor is a part of changes. As a result, measurement circuitry 110 may measure a change in impedance, frequency, current, charge, electrical energy, magnetic energy, or voltage of the affected sensing coil and/or its LC tank. As is known in the art, said measurement IC may be configured or calibrated with a predetermined base line for any of these electrical characteristics and for each coil 101, 102 and 103 respectively, such that any change in sensor coils 101, 102 and/or 103 may be evaluated relative to said baseline. Additionally, and as is known in the art, the measurement circuitry 110 may be configured with one or more predetermined thresholds for these electrical characteristics. This way, a clear ‘detected’ state may be triggered by the measurement circuitry for a specific sensing coil(s) 101, 102 or 103 when the float 105 and its interfering member 104 overlap with said specific sensing coil(s) 101, 102 or 103.

The embodiment in FIG. 1a therefore illustrates sensing system 190 configured to sense a position of an object 105 along a sensing axis 114, said sensing system 190 comprising a plurality of sensing coils 101, 102, 103 arranged along said sensing axis 114, a covering member 100, wherein the plurality of sensing coils 101, 102, 103 are positioned on a first side 100a of said covering member, and wherein the object 105 is positioned on a second side 100b of the covering member 100, measurement circuitry 110 coupled to the plurality of sensing coils 101, 102, 103, wherein the measurement circuitry 110 is configured to measure a change of inductance of said sensing coils 101, 102, 103, said change of inductance caused by an interfering member 104 adjacent to the object 105, said interfering member 104 having an interfering magnetic field 104a, and wherein said interfering member 104 is configured to affect at least one of the plurality of sensing coils 101, 102, 103 along the sensing axis 114 at any given position along the sensing axis 114, and wherein the measurement circuitry 110 e.g. a processor is further configured to determine the position of the object 105 along the sensing axis 114 based on the inductance change caused by the interfering magnetic field 104a of the interfering member 104 as part of the object 105.

In an alternative embodiment shown in FIG. 1b, a sectional side view of the inductors 101, 102 and 103 is illustrated where inductors 101, 102 and 103 may be mounted on and wound around a PCB 180 (not accurately drawn) that is interior to an enclosure or tube or covering member 100. In this embodiment, the central axes of the coils 101, 102 and 103 are also aligned with (and substantially parallel to) sensing axis 114. In this case, the connections 101a, 102a and 103a may be routed on the PCB 180 (since the coils 101, 102 and 103 terminate on the PCB 180) and the resonant tank capacitors (not shown) may be positioned near each coil 101,102 and 103. The L and C values are chosen to provide a resonating circuit at a predetermined frequency. FIG. 1b further shows a sectional view of a band-shaped interfering member 104, also illustrated in FIG. 1a, which is exterior to enclosure 100. The width d may be chosen such that the member 104 (at least partially) overlaps with sensor coils 102 and 103, which may be beneficial since there are no signal dead zones as the interfering member 104 moves from coil 103 to 102, or vice versa. Instead, it may be observed that the signal relating to the inductance change of inductance of coil 102 increases (meaning increasingly detects member 104) while a decreasing measurement signal is observed for coil 103 as member 104 moves to the right along the sensing axis 114.

The buoyancy and weight can be used to determine the precise submersion level of said float 105 if required for more accurate level measurements.

In one embodiment, the sensing system illustrated in FIG. 1a or 1b is able to detect turbulence in the liquid level 107 of the container 109. If the sensing coils 101, 102 and 103 are spaced along the sensing axis 114 in a manner that facilitates a high resolution of level 107 sensing, then the degree of turbulence can be derived by the measurement circuitry 110 through the sensing information of coils 101, 102 and 103, since turbulent liquid may create waves on the level 107. Said waves may cyclically affect adjacent coil sets as the waves move the float 105 up and down in a cyclical manner. This cyclical or ‘up-and-down-and-up-again’ behavior may be detected by the sensing coils 101, 102 and 103, and may be ascribed to turbulence in the level 107.

In a further embodiment, the sensing coils 101, 102 and 103 are able to sense liquid leakage into the tube 100. When the interfering member 104 is configured to be metal, it has a suppressive effect on the sensing coils 101, 102 and 103 with which it overlaps. However, liquid build-up within the tube 100 (in the volume where the sensing coils 101, 102 and 103 are located), will lead to an increase in parasitic capacitance between the windings of each of the coils 101, 102 and 103. Said increase in parasitic capacitance has an opposite effect in the sensing signal to that of the interfering member 104, thus making a leak clearly identifiable from the sensing signals obtained from coils 101, 102 and 103 by the measurement circuitry 110.

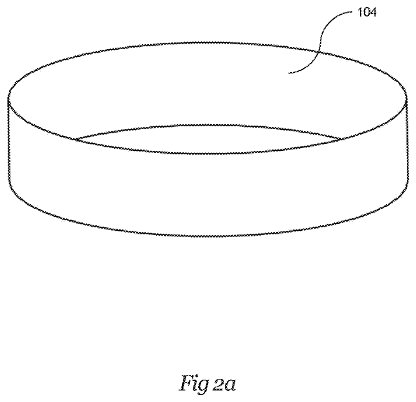

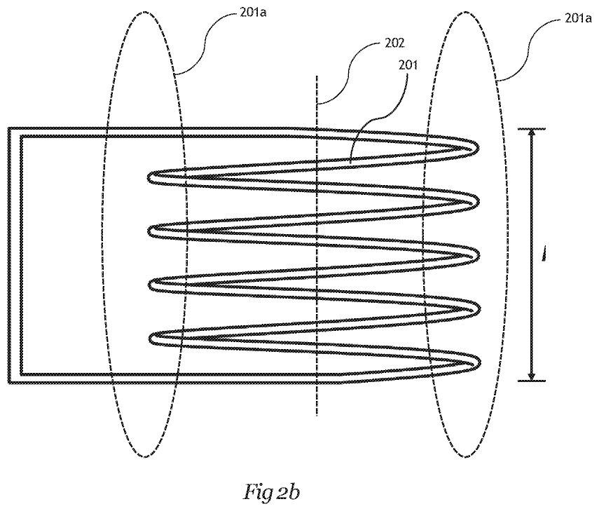

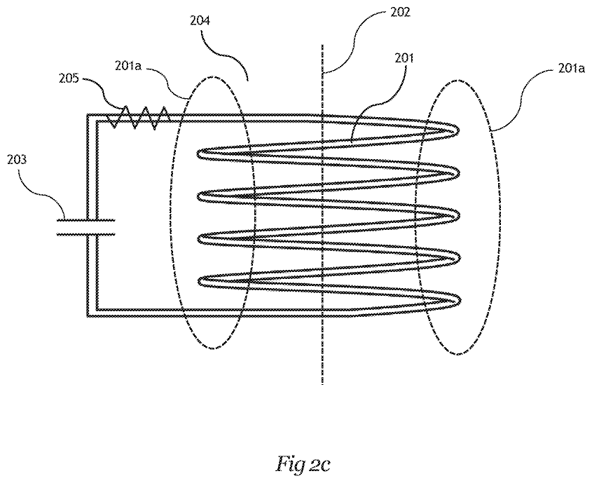

FIGS. 2a to 2c show various inductance interfering configurations. In FIG. 2a, an electrically conducting metal band 104 (such as copper or aluminum) is shown, which may be attached to the exterior of the float 105 or embedded into it. In a preferred embodiment, the band or interfering member 104 must be positioned adjacent to the inner diameter of the circular float 105. In a further ideal configuration, the band 104 is sealed from the fluid. The metal band 104 may be seen as having an interfering magnet field 104a (as illustrated in FIG. 1a) resulting from Eddy current losses that are induced by the sensing coils 101, 102 or 103. Since the metal band 104 is configured to always overlap with at least one of the sensing coils 101, 102 or 103 at any position along sensing axis 114, the interfering magnetic field 104a may always be present when the sensing coils 101, 102 and 103 are switched on for sensing.

In FIG. 2b, a wired solenoid coil 201 with shorted ends is shown. This coil may also act as an interfering member, since if coil 201 is attached to or embedded into float 105, coil 201 will produce an interfering magnetic field 201a that opposes the magnetic field of the sensing coils with which the float overlaps. For this reason, and to distinguish its purpose from coils 101, 102 and 103, coil 201 may be referred to as an interfering coil. Interfering coil 201 may be wound about an axis 202, which will henceforth be referred to as its core axis. Interfering coil may be made from any suitable conducting material but in a preferred embodiment, interfering member 201 is made from copper or aluminum. The number of turns, radial width and axial length may vary to meet the needs of the application. For example, its axial length l may be chosen such that when interfering coil 201 is attached to or embedded into a float 105, it overlaps and therefore interferes with more than one sensing coil at a time, similar to how the width d of the metal band interfering member 104 is configured.

A preferred embodiment is shown in FIG. 2c, wherein the interfering coil 201 is paired with a capacitor 203 to form a passive resonant LC tank circuit 204. It is known in the art that the resonant frequency fᵣₑₛ of circuit 204 is a function of its inductance L (primarily determined by coil 201) and its capacitance C (primarily determined by capacitor 203). Furthermore, if the resonant frequency of LC tank 204 is equal or nearly equal to the predetermined excitation frequency that is output by measurement circuitry 110 to the sensor coils 101, 102, and 103, the LC tank 204 will have the greatest interference effect on sensing coils 101, 102, and 103. Thus, the radial width, axial length and number of turns of coil 201, as well as the size of capacitor 203 may be configured and predetermined during the design stage of LC tank 204 such that its resonant frequency is equal to or nearly equal to the excitation frequency of processor 110. More than one capacitor 203 may be used in series or parallel to help fine tune LC tank 204. Similarly, other passive components like inductor components and resistive components may be added to ensure the LC tank 204 achieves a good interference effect on the sensor coils 101, 102, and 103. As with the embodiment in FIG. 2b, the LC tank 204 may be embedded into or attached onto float 105, which requires the coil 201 to have a diameter that is at least greater than that of the tube 100. For the purpose of affecting more than one sensor coil 101, 102 or 103 at a time, the axial length of coil 201 in the LC tank may also be extended. However, this may affect the inductance of coil 201 and by extension its resonant frequency. In this case, a plurality of LC tanks may be embedded into float 105 and shielded from each other to extend its axial interference ability (or axial ‘reach’).

LC tank circuit 204 may optionally comprise a resistive component 205, to fine-tune its effect on the sensing coils 101, 102 and 103 making it an RLC circuit. Furthermore, as with the shorted inductor in FIG. 2b, the LC circuit 204 may be seen as having an interfering magnetic field 201a that affects the inductance of sensing coils 101, 102 and 103 and which is also induced by the sensing coils 101, 102 and 103.

The coil 201 of the LC tank 204 may be said to have a core axis 202 that extends through the core of the inductor 201. In view of FIG. 1a, it can also be said that since coil 201 may be embedded into float 105 by wrapping around the tube 100, the core axis 202 may be said to approximately align with the sensing axis 114, and that the sensing axis 114 is parallel or substantially parallel to the core axis 202 of coil 201.

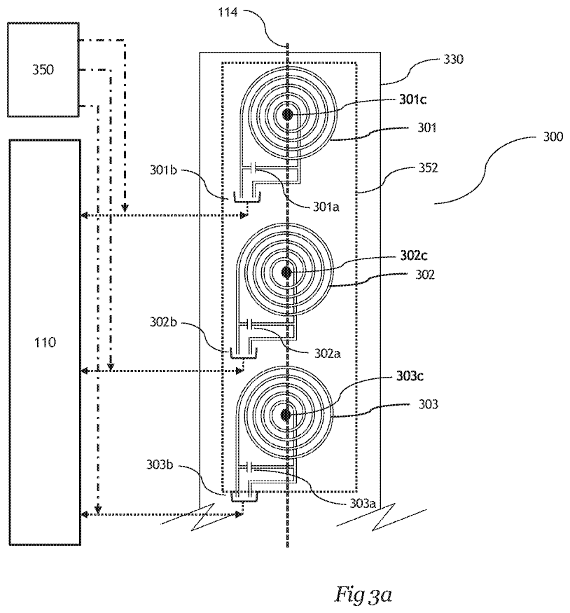

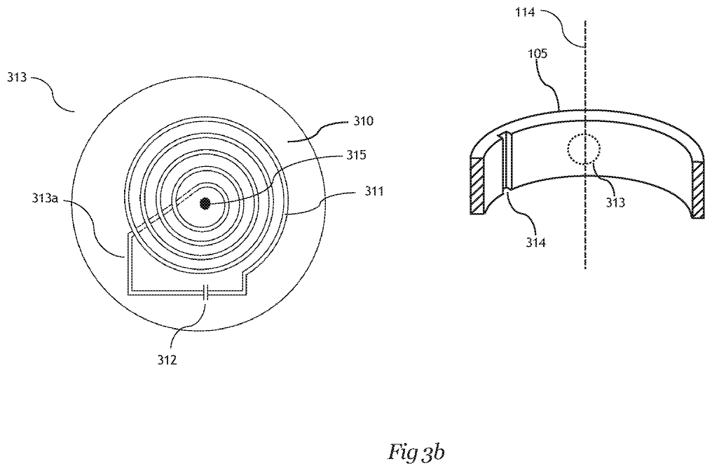

In FIG. 3a, a sensing system 300 comprising a planar coil PCB 330 is shown comprising 3 planar circular coils 301, 302 and 303 which are formed by tracks on the PCB and are used as the sensor coils. It is also clear that in this configuration, the core axes 301c, 302c and 303c of each respective sensor coil 301, 302 and 303 are perpendicular or substantially perpendicular to the sensing axis/direction 114. Each sensor coil 301, 302 and 303 respectively has at least one capacitor 301a, 302a and 303a. Effectively, each sensing coil 301, 302 and 303 is part of an active LC-tank system, which may be excited by (with an excitation signal at a predetermined frequency) and measured by the measurement circuitry 110 via terminals 301b, 302b and 303b respectively for each sensor coil (or sensor LC tank circuit, to be more complete). The number of sensing coils may be more or less than three, depending on the length of the sensing axis 114, and the diameter of each coil may vary to ensure a good sensing signal for a given target (not shown) distance.

While it is common to use the processor 110 to excite and measure the sensor coils, it may occur that environmental changes affect measurement in such a manner that false signals or signal drift occurs when measuring sensor coils 301, 302 and 303. For this reason, an external oscillator source 350 may be used to excite LC circuits 301, 302 and 303, while the processor 110 is used to measure the output via terminals 301b, 302b and 303b.

The PCB 330 can be single or multi-layered and the sensing coils 301, 302 and 303 can be designed accordingly. Sensing coils 301, 302 and 303, while shown to be circular, may be square, rectangular, hexagonal or any appropriate shape. To protect the sensing coils 301, 302 and 303 from rear-side interference, a ferrite sheet 352 may be placed on the side of PCB 330 that is not facing the interfering member (not shown). In view of FIG. 3a, the ferrite sheet 352 may be placed on the bottom/rear layer of PCB 330, if coils 301, 302 and 303 are positioned on the top/front layer of PCB 330. In this embodiment, each coil 301, 302, 303 is paired with a capacitor 301a, 302a, 303a to form a resonant LC tank. The connections are routed on the PCB 330 to measurement circuitry 110 or to another mechanism to measure a change in the inductance or a change in the impedance of the LC tanks. Any number of coils can be used as required by the application.

On the left-side of FIG. 3b, an interfering coil 311 in the form of a planar-wound wire or in the form of traces on a PCB 310 is shown. A capacitor 312 is attached to the ends of coil 311, so as to form a passive resonant coil circuit 313a. The coil 311 may be designed and the capacitor 312 chosen such that the passive resonant coil circuit 313a has a predetermined resonant frequency fᵣₑₛ. When coil 311 is designed and capacitor 312 chosen such that the fᵣₑₛ of circuit 313a is equal to or approximately equal to the excitation frequency of measurement circuitry 110 (or external clock source 350 if used), then the circuit 313a on substrate 310 may be viewed as a passive resonant interfering member 313 with an interfering magnet field (not shown here), that may be used to affect sensing coils 301, 302 and 303. Therefore, the interfering member 313 may be embedded into float 105 as shown on the right-side of FIG. 3b. To ensure proper alignment of the interfering member 313 with the sensing coils 301, 302 and 303, a mechanical key mechanism 314 may be used as part of the float 105, that mates with another key mechanism on tube 100, in order to avoid rotation of the interfering member about the sensing axis 114, since any significant rotation would cause the interfering member 313 to become misaligned with the sensing coils 301, 302 and 303. When the interfering member 313 is embedded into float 105, the measurement circuitry 110 may monitor sensing coils 301, 302 and 303 for a change of inductance due to the interfering member 313 overlapping or partially overlapping with one of the sensing coils 301, 302 and 303, and then use the change of inductance observed to determine the position of the interfering member 313 and by extension float 105 along the sensing axis 114. In this embodiment, the core axis 315 of the coil 311 is perpendicular or nearly perpendicular to the sensing axis 114, but parallel or approximately parallel with the core axes 301c, 302c and 303c of sensing coils 301, 302 and 303.

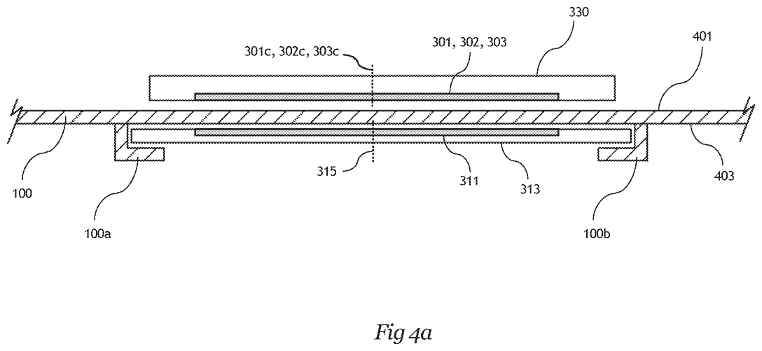

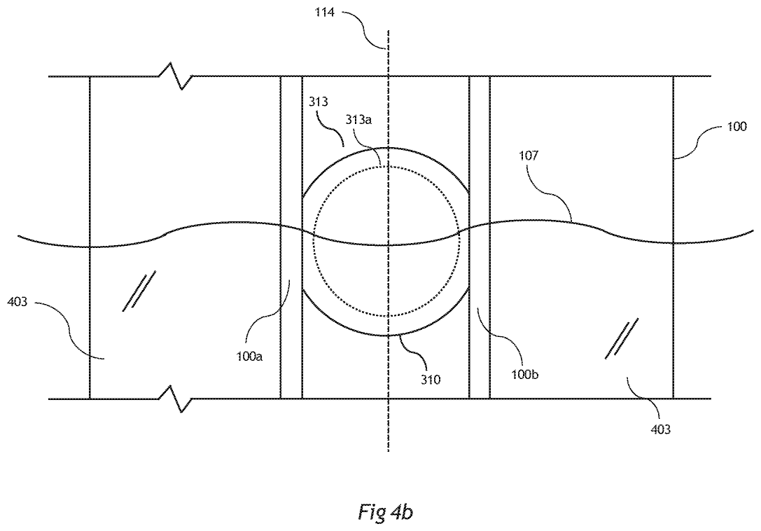

In an alternative embodiment, PCB 330 is positioned on a first side 401 of covering member 100 (or tube 100), as shown by the top-down sectional view of FIG. 4a. On the second side or liquid side 403 (that is opposite to the first side 401) of covering member 100, interfering member 313 is positioned such that it is within interfering range of the sensing coils 301, 302, 303 on PCB 330. Interfering member 313 is illustrated in this embodiment as having a body 310 of a disk (as shown by side view in FIG. 4B), and the body 310 forming part of interfering member is chosen such that it is buoyant (e.g. a plastic body with an internal air volume to facilitate floating). Guiding members 100a and 100b (e.g. flanges, rails or brackets) that form part of the covering member 100 may be used to guide the interfering member 313 along the sensing axis 114, and also to help maintain a relatively constant distance between the interfering member 313 and the sensing coils 301, 302 and 303, thus keeping interfering member 313 adjacent to the second side 403.

FIG. 4b is a side view of the embodiment in FIG. 4a, wherein the interfering member 313 with its disk-shaped body 310 floats within the liquid volume 107. The interfering member 313 need not be shaped in disk form, but may take on any shape to minimize friction within the guiding members 10a and 100b, and also to facilitate buoyancy within liquid 107. The interfering member may be physically designed to float more or less, as a means of finer adjustment of its floating position thereby obtaining a specific position relative to the level of the liquid 107, as is known in the art. Overall, the sensing coils 301, 302 and 303 may be used to derive the level of liquid 107, based on the position of the interfering member 313 along the sensing axis 114.

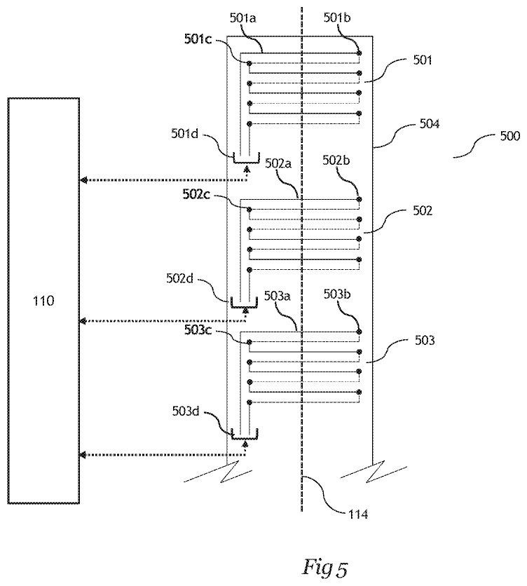

Yet another embodiment is shown in FIG. 5, wherein a PCB 504 comprises stitched sensing coils 501, 502 and 503. Coils 501, 502 and 503 are referred to herein as ‘stitched’, because each of these coils has a single trace 501a, 502a and 503a that routes on a top layer of the PCB 504, through a PCB via 501b, 502b and 503b to a rear/bottom layer of the PCB, then through another via 501c, 502c and 503c back to the top layer, and so on until a solenoid-like PCB coil is achieved, with a core axis that aligns with the sensing axis 114. This embodiment is advantageous in that it provides a cost-effective way to implement discrete, solenoid-like coils without wire winding as illustrated in FIGS. 1a and 1b. While the windings of coils 501, 502 and 503 are shown to be rectangular shaped, they may also be stitched through the PCB layers in a curved or diagonal style, and more than two layers on the PCB may be used to facilitate the routing of connections 501d, 502d and 503d to the measurement circuitry 110. As with the embodiment in FIG. 3a, capacitors may be added to the ends of the coils 501, 502 and 503 on PCB 504 to form resonant LC-tank circuits, that may be excited and measured by measurement circuitry 110. Any number of coils may be used as required by the desired length to be sensed along axis 114.

A key difference between the embodiments in FIGS. 3a and 5a is that the core axes 301c, 302c and 303c of coils 301, 302 and 303 are perpendicular or nearly perpendicular to the sensing axis 114, and therefore the sensing system 300 of FIG. 3a is compatible with the interfering member 313 as illustrated in FIG. 3b. The sensing system 500 in FIG. 5 on the other hand, requires the interfering member to be in the form of the embodiments in FIG. 2a, 2b or 2c given that the core axes (not shown) of coils 501, 502 and 503 are aligned with the sensing axis 114, or in other words parallel or nearly parallel to the sensing axis 114.

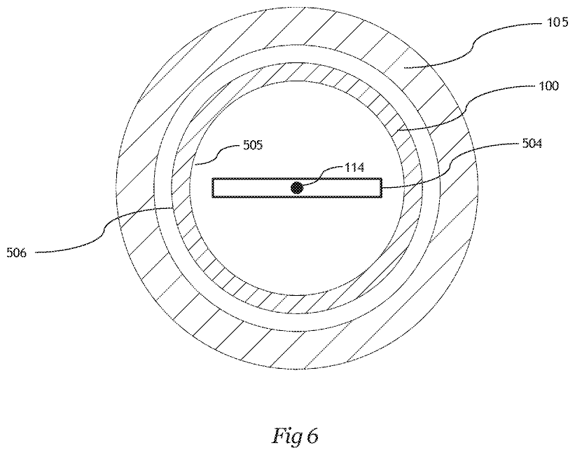

FIG. 6 is a sectional top-down view of the placement of PCB 504 within a first side or surface 505 (non-liquid side) of a covering member (tube) 100. The outer, second side 506 of the cover member 100 is surrounded by a float object 105 in this case of annular form. Preferably, the PCB 504 is placed in the center of covering member 100 or nearly center, as this would produce the most similar signal response throughout the coils 501, 502 and 503 as the float 105 (that contains the interfering metal band 104 in FIG. 2a or the shorted inductor 201 from FIG. 2b or preferably the LC tank interfering member 204) moves up and down the covering member 100 along sensing axis 114.

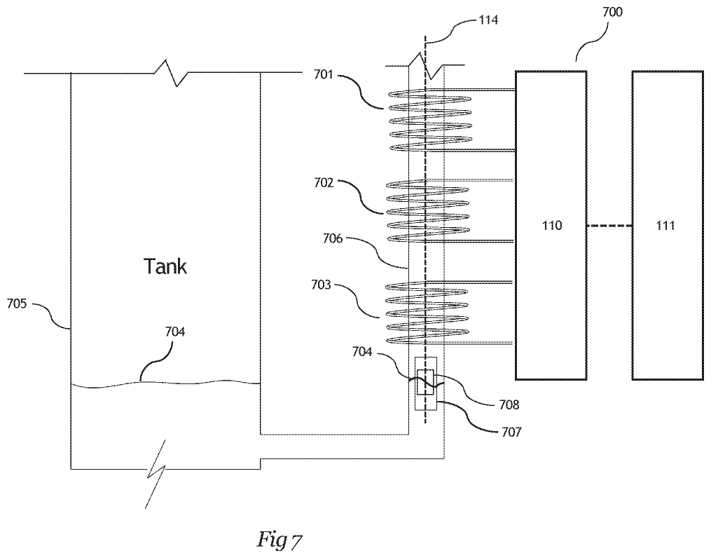

Up to this point, the sensing coils have been illustrated to be interior to a covering member or tube, while the interfering member is external to the covering member. However, the reverse of this embodiment may also be achieved by the present invention. An exemplary embodiment of a sensing system 700 comprising wire wound coils 701, 702 and 703, measuring circuitry 110 and a user interface system 111 is illustrated in FIG. 7. The level 704 in a tank 705 will be the same in both the tank 705 itself as well as a sight tube 706, and so the coils 701, 702 and 703 may be wrapped around the tube 706 on its exterior surface, while a float 707 is positioned on the interior of tube 706 and moves up and down with the liquid level 704. The float may contain an interfering member 708 to pass through the cores of coils 701, 702 and 703 along the sensing axis 114. The interfering member 708 may have an outer surface made of a electrically conductive material such as copper or aluminum which allows eddy currents to form on the interfering member that suppress the inductance of coils 701, 702 and 703, said suppression being detectable by the measurement circuitry 110 monitoring characteristics such as inductance change, electrical current change, voltage change or frequency change in the coils 701, 702 and 703. Alternatively, interfering member may comprise a magnetically permeable material such as ferrite, which increases the inductance and strengthens the magnetic field of coils 701, 702 and 703 as it pass through their cores. Said increase may also be observed by the measurement circuitry 110 using the same characteristics.

In an alternative embodiment, interfering member 708 may be the shorted coil 201 in FIG. 2b or the LC tank circuit 204 in FIG. 2c. The measurement circuitry may be configured to determine the liquid level 704 in tank 705 using the coils 701, 702 and 703 that are wrapped around tube 706. The results may be illustrated, analysed or processed further on a user interface system 111, such as a mobile device, screen, LED lights, computing device or the like.

In yet another embodiment, the coils 701, 703 and 703 may be planar coils such as coils 301, 302 and 303 on a PCB 330, which are attached to the outer surface of tube 706, similar to the embodiment in FIG. 4a.

The dimensions of the float 707 and also the interfering member 708 can be such to start affecting a neighboring inductor as it moves out of the inductor it is mostly covering. This will allow for relative position determination between two inductors.

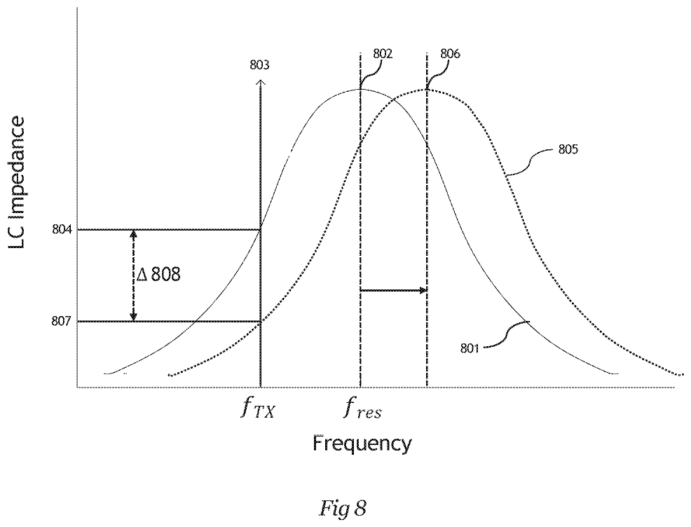

A typical impedance response over frequency is shown in FIG. 8 for an LC tank as is known in the art. Each of the aforementioned sensing coils which is configured in an LC-tank configuration will exhibit an impedance response 801, which has a resonant peak 802 at a frequency fᵣₑₛ. A predetermined excitation signal 803 may be output by the measurement circuitry 110 or external source 350 at point 803 or f_{TX}, said point 803 being to the left or the right of peak 802. If response 801 is the response when no interfering member is present, then the baseline impedance is given by point 804. When an interfering member, such as the passive resonant circuit 204 or 313, metal band 104 or the shorted coil 201, interferes with the aforementioned sensing coils, said sensing coils may exhibit a new response 805 with a peak 806 due to the inductance-suppressing nature of the aforementioned interfering members. At the same excitation frequency 803, a different impedance 807 may be observed by the measurement circuitry 110. The change of inductance, therefore, may be derived from the delta 808. In this regard, the measurement circuit 110 may obtain a measurement signal relating to the change of inductance from a sensing coil by measuring the change in impedance shown by 808, a change in the frequency from point 802 to 806, a change in LC-tank voltage due to delta 808 or a change in electrical charge or electrical current due to delta 808.

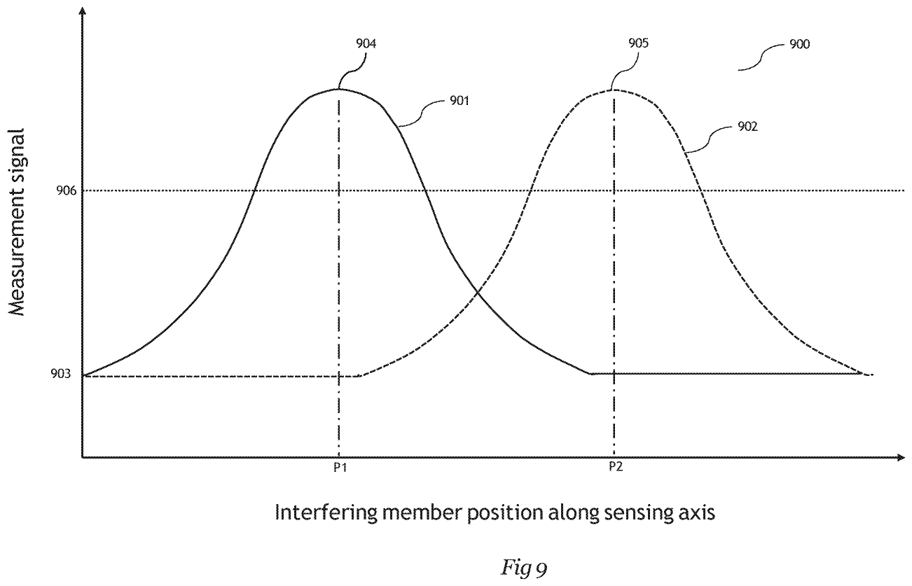

FIG. 9 shows exemplary measurement signals 901 and 902 for two adjacent sensing coils (for example sensing coils 502 and 503 respectively) captured by the measurement circuitry 110. The plot 900 shows how, for example the measurement signal 901 of sensing coil 503 changes when an interfering member (such as LC Tank circuit 204) moves over sensing coil 503 from the bottom of sensing axis 114 in an upwards direction along sensing axis 114 as shown in FIG. 5. Baseline 903 shows a point of no interference or little interference and as the interfering member starts to overlap, the measurement signal changes up to a full overlap point 904 for a maximum measurement signal. When the interfering member 204 continues moving towards coil 502 and starts to overlap with it, the measurement signal 904 reduces in interference while the measurement signal 902 of coil 502 starts to increase, up to a full overlap between interfering member 204 and sensing coil 502 at point 905.

A preferred response is shown in FIG. 9, in that interfering member 204 (due to its physical and electrical configuration) is able to affect the two sensing coils 503 and 502 simultaneously, thereby resulting in full coverage of movement of the interfering member 204 along the sensing axis, with no signal dead spots. This is not a strict requirement for this embodiment, however.

The measurement signals 904 and 905 may be evaluated by measurement circuitry 110 in an analog fashion to obtain an analog (or continuous) position reading of the interfering member 204. Alternatively, at least one threshold 906 may be used for a more discrete position approach. For example, measurement circuit 110 may be configured to register that the interfering member 214 (and by extension, object 105) is at position P1 along the sensing axis 114 when signal 901 is above threshold 906. Similarly, the measurement circuit 110 may register that the interfering member 214 (and by extension, object 105) is at position P2 along the sensing axis 114 when signal 902 is above threshold 906. It is not strictly required to use a single threshold; multiple thresholds may respectively be applied to the measurement signal of each sensing coil. Furthermore, the upwards movement of the signal is exemplary, and a downwards movement of signals 904 and 905 in the presence of an interfering member 214 is also possible, depending on the unit of the measurement signal, which may be Hz for frequency, volts for voltage, amperes for current measurement, counts for charge transfer measurements, coulomb for charge extracted from the sensing coils, or ohms for impedance.

The covering member 100 has been illustrated as being non-metallic, and the interfering members have been illustrated as being electrically conductive or magnetically permeable. However, when the covering member 100 is made of a metallic material, such as aluminum, copper, stainless steel, or carbon steel that is electrically conductive, it becomes difficult to sense the position of an object 105 at a sensing/excitation frequency of above 50 kHz. It may be necessary to operate above 50 kHz to meet sample rate specifications, to ensure more power efficient operation, or to meet the requirements of a specific measurement circuit 110. To this end, this invention provides a method for performing high-frequency sensing (greater than 50 kHz) through electrically conductive metallic cover members.

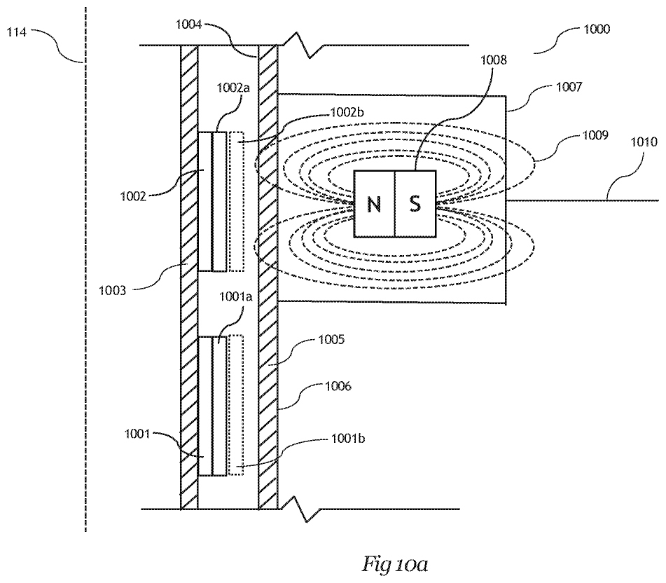

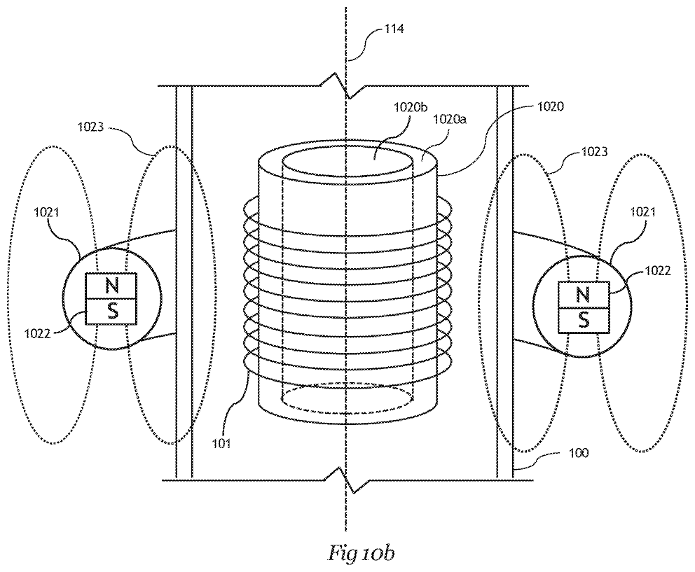

In FIG. 10a, an exemplary embodiment of a sensing system 1000 is provided comprising a plurality of sensing coils 1001 and 1002 in the form of PCB traces (for example as illustrated in FIG. 3a) on a PCB 1003 (equivalent to PCB 330). The PCB 1003 may extend along a sensing axis 114 and may be positioned on a first side 1004 of a covering member (or enclosure/tube) 1005. A float or an object 1007 may be adjacent to the covering member 1005 on a second side 1006 of the covering member 1005. An interfering member 1008 in the form of a polarized magnet may be attached to or embedded into object 1007 for the purpose of interfering with the sensing coils 1002 and 1003. Said interference may be as follows: each coil 1002 and 1003 has an adjacent magnetically permeable material layer 1001a and 1002a (such as ferrite sheet), which may enhance/increase the inductance of said coils 1001 and 1002. Ferrite layers 1001a and 1002a may also be one continuous layer covering all the sensing coils. When the interfering member 1008 overlaps with the sensing coils 1001 and 1002, its interfering magnetic field 1009 (which is the magnetic field of the magnet 1008) changes the properties of the corresponding magnetically permeable layer 1001a and 1002a in such a way that the inductance enhancing ability is lost. As a result, the corresponding coil(s) 1001 and 1002 may experience a reduction in inductance, which is measurable in the same way as described in the previously described embodiments. This change in inductance can therefore be used to determine the liquid level 1010 in a container (not shown) if object 1007 is a liquid float. More generally, this loss of inductance method can be used to determine the position of object 1007 along a sensing axis/sensing direction 114.

The magnet or interfering member 1008 may take many forms. Examples may include a polarized ring magnet that is radially magnetized (as illustrated in FIG. 10a), diametrically magnetized or axially magnetized. In the case where the object or float 1007 is on the interior of a tube 706 as shown in FIG. 7, interfering member 708 may for example be a rod magnet that is axially magnetized or diametrically magnetized, or an axially magnetized sphere magnet. In the case of the embodiments illustrated in FIGS. 3a, 3b, 4a and 4b, the interfering member 313 may instead be a disc magnet that is axially or diametrically magnetized. It is required, however, that the embodiments referred to here have a magnetically permeable layer, such as ferrite core or ferrite sheet, adjacent to their sensing coils such that an inductance change occurs when the interfering magnet moves along the sensing axis.

The interfering member or magnet 1008 may have any strength grading. Higher strength magnet grades will afford better sensing resolution for measurement circuitry 110, or the ability to sense the object 1007 from further away at a given sensing resolution. Any magnetic material may be used, including but not limited to Neodymium, Samarium Cobalt, Ceramic or Ferrite, or Alnico-type magnets. Magnet 1008 may also be a multipole magnet or in special cases, an electromagnet.

In the embodiment of FIG. 10a, covering member 1005 may be made of a metallic, electrically conductive material such as stainless steel, but may also be made of any of the non-metallic materials noted for previous embodiments. The embodiment of FIG. 10a may also exhibit the measurement signal profiles illustrated in FIG. 9.

In a further embodiment, electrically conductive layers 1001b and 1002b (such as a metallic layer made of copper or aluminum or the like) may be placed adjacent to the ferrite layers 1001a and 1002a, which has the benefit of improved signal strength observed by sensing coils 1001 and 1002. This is because when the interfering member 1008 is not nearby and no sensing coil interference occurs, the ferrite layers 1001a and 1002a enhances the inductance of coils 1001 and 1002 respectively, while also shielding coils 1001 and 1002 from the eddy current losses (or inductive suppression) that would have occurred due to the nearby placement of electrically conductive layers 1001b and 1002b. When the interfering member 1008 overlaps with coils 1001 and 1002, or is close enough such that the interfering magnetic field 1009 is able to change the material properties of the layers 1001a and 1002a, a double effect occurs relating to the inductance of coils 1001 and 1002. The first effect is that the inductance gained by coils 1001 and 1002 due to the ferrite layers 1001a and 1002a is lost, since the interfering magnetic field 1009 may saturate the ferrite layers 1001a and 1002a such that their relative permeability drops significantly (approximately to that of air, thus μᵣ≈1), which causes a first change in inductance of coils 1001 and 1002. More or less simultaneously, a second effect occurs where the coils 1001 and 1002 are exposed to the electrically conductive layers 1001b and 1002b (because the ferrite layers 1001a and 1002a are now saturated and have lost their shielding ability), which now form eddy currents (with their own additional interfering magnetic fields) that suppress the inductance of coils 1001 and 1002 even further, thus causing a second change in inductance. The first and second effects lead to a sensing signal measurable by the measurement circuitry 110 that is significantly greater than when only ferrite layers 1001a and 1002a are used. It should be noted that while the aforementioned effects are described as having a first and a second change in inductance, these changes happen more or less simultaneously, and the result is that measurement circuitry 110 is able to obtain even greater signal strength compared to only having ferrite layers 1001a and 1002a.

The same double-effect is achievable if covering layer 1005 is made from a metallic layer that is electrically conductive. Then, instead of adding metallic layers 1001b and 1002b, the PCB 1003 with coils 1001 and 1002 along with their respective ferrite layers 1001a and 1002a may be positioned substantially against the first side 1004 of covering layer 1005. In this case, the covering layer 1005 is also the electrically conductive layer 1001b/1002b.

The ferrite layers 1001a and 1002a along with the electrically conductive layers 1001b and 1002b may also be placed on the other side of PCB 1003, or on both sides for an even greater signal strength. If the cores of coils 1001 and 1002 are hollow, then ferrite and metallic inserts may be used to accomplish this double effect. For example, consider the embodiment in FIG. 1a. Each coil may be outfitted with a ferrite-metallic core as illustrated in FIG. 10b and explained next.

One of the sensing coils 101 is illustrated in FIG. 10b as having a two layered core 1020, comprising of an outer layer 1020a and an inner core 1020b. The outer layer may be made from a highly magnetically permeable material such as ferrite, while the inner core may be furnished from a highly electrically conductive material such as aluminum, copper, etc. As with the previous embodiment, the outer layer 1020a increases the inductance of coil 101, while also shielding it from the suppressive effects of the inner core 1020b. When an object (or float) 1021 containing an interfering member 1022 (in this case a ring magnet) that has an interfering magnetic field 1023 is in the vicinity of the coil 101, the ferrite outer layer 1020a is saturated and the inductance enhancement for coil 101 is lost. At the same time, and due to the saturation of outer layer 1020a, the inner core 1020b starts affecting coil 101 and suppresses the inductance of coil 101 by means of eddy-currents forming on the surface of core 1020b. Therefore, a change of inductance may be measured by the measurement circuitry 110 coupled to coil 101, wherein the change of inductance is due to the simultaneous loss of inductance enhancement by the magnetically permeable material (outer layer 1020a) and the inductance suppression by the metallic layer (inner core 1020b).

The two-layered core 1020 may act as the supporting structure for all the sensing coils along the sensing axis 114, and thus only a portion of it is shown in FIG. 10b. More than one magnet 1022 may be embedded into the object or float 1021, thereby shaping and orienting the interfering magnetic field 1023 for a more targeted effect on the sensing coils.

While the sensing system disclosed herein is primarily described in context of liquid level sensing, the measuring techniques are extendable to other applications. For example, in view of FIG. 1, the object 105 may be a user interface member, such as a slider knob which is a part of an electrical appliance device and which is slidable in a sensing direction 114 by a user, along which sensing coils 101, 102 or 103 detect the position of the slider knob.

While a sensing axis 114 was defined throughout this disclosure for one dimensional position sensing, those skilled in the art may easily extend the sensing axis 114 to a sensing plane offering two-dimensional X-Y position sensing using an object that contains an interfering member with interfering magnetic fields.

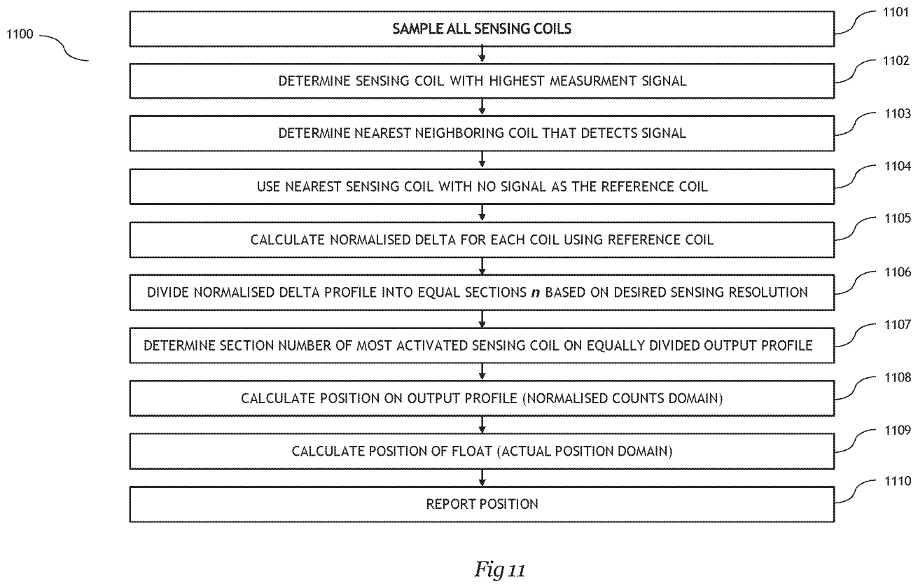

FIG. 11 shows an exemplary method for determining the position of an object or float 105 (or any of the other embodiments' floats). As a first step in 1101, all the sensing coils are sampled by the measurement circuit 110. Thereafter in step 1102, the sensing coil exhibiting the highest measurement signal is determined, followed by step 1103 wherein the nearest neighboring sensing coil that also exhibits some level of signal is identified for the purposes of determining on which side of the highest measuring coil the object is located. Then in step 1104, the nearest sensing coil with no signal is identified and designated as the reference coil, which is then used to normalize the deltas detected by other sensing coils in step 1105, thereby creating a normalized delta profile of all sensing coils. In step 1106, the normalized delta profile is divided into n number of sections, where n denotes the desired resolution steps within the position detection of the object. In step 1107, the section from 1106 that has the highest normalized delta is determined and in step 1108, the position on an output profile is calculated, followed by the final calculation of the float or object in step 1109. The position 1110 is then reported by the measurement circuitry 110, analysed further for turbulence or leakage, or forwarded to the user interface device 111.

1. A sensing system configured to sense a position of an object along a sensing axis, said sensing system comprising a plurality of sensing coils arranged along said sensing axis, a covering member, wherein the plurality of sensing coils are positioned on a first side of said covering member, and wherein the object is positioned on a second side of the covering member, measurement circuitry coupled to the plurality of sensing coils, wherein the measurement circuitry is configured to measure a change of inductance of said sensing coils which is caused by an interfering member adjacent to the object, said interfering member having an interfering magnetic field, and wherein said interfering member is configured to affect at least one of the plurality of sensing coils along the sensing axis at any given position along the sensing axis, and wherein the measurement circuitry is further configured to determine the position of the object along the sensing axis based on the inductance change caused by the interfering magnetic field of the interfering member as part of the object.

2. The sensing system of claim 1, wherein the object is a liquid float, and wherein the covering member is a sealed enclosure, and wherein the sensing system is used to determine the level of a liquid in a container by measuring the position of the interfering member attached to the liquid float.

3. The sensing system of claim 1, wherein the measurement circuitry is configured to apply an excitation signal at a predetermined frequency to said plurality of sensing coils, and wherein the interfering member is a passive resonant circuit comprising an interfering coil and a capacitor, the passive resonant circuit having a resonant frequency that is equal to or substantially equal to the predetermined frequency of the excitation signal, and wherein the interfering magnetic field is the magnetic field induced in the interfering coil in response to at least one of the plurality of sensing coils.

4. The sensing system of claim 3, wherein the core axes of the plurality of sensing coils are parallel or substantially parallel to the sensing axis, and wherein the core axis of the interfering coil is also parallel or substantially parallel to the sensing axis.

5. The sensing system of claim 4, wherein the plurality of sensing coils are stitched coils on a printed circuit board.

6. The sensing system of claim 3, wherein the plurality of sensing coils are formed by traces on a first printed circuit board, and wherein the core axes of the plurality of sensing coils are perpendicular or substantially perpendicular to the sensing axis, and wherein the interfering coil is also formed by traces on a second printed circuit board, and wherein the core axis of the interfering coil is perpendicular or substantially perpendicular to the sensing axis.

7. The sensing system of claim 1, wherein the interfering member is configured to affect at least two of the plurality of sensing coils along the sensing axis at any given position along the sensing axis.

8. The sensing system of claim 2, further comprising a user interface device that is connected to the measurement circuitry to provide user feedback regarding the level, turbulence or leakage status within the liquid container.

9. The sensing system of claim 1, wherein the interfering member is a polarized magnet, and wherein the sensing system further comprises a magnetically permeable layer positioned adjacent to the plurality of sensing coils to enhance the inductance of said plurality of sensing coils, and wherein the interfering magnetic field is the magnetic field of the polarized magnet, and wherein the change of inductance is due to the magnetic field of the polarized magnet changing the material properties of the magnetically permeable layer.

10. The sensing system of claim 9, wherein the sensing system further comprises a metallic layer, said metallic layer being positioned such that it does not interfere with the inductance of the plurality of inductors in the absence of said polarized magnet, and wherein said change of inductance measured by the measurement circuitry is due to the simultaneous loss of inductance enhancement by the magnetically permeable material and the inductance suppression by the metallic layer in the presence of the polarized magnet.

11. The sensing system of claim 9, wherein the magnetically permeable layer comprises a plurality of ferrite sheets respectively corresponding to the plurality of sensing coils.

12. The sensing system of claim 9, wherein the interfering member selected from is a a polarized disk magnet, polarized rod magnet and a polarized ring magnet.

13. The sensing system of claim 9, wherein the measurement circuitry has a predetermined excitation frequency that is higher than 50 kHz.

14. The sensing system of claim 10, wherein the covering member is also the metallic layer.

15. A method for configuring a sensing system to sense a position of an object along a sensing axis, the method comprising the steps of arranging a plurality of sensing coils along said sensing axis, positioning the plurality of sensing coils on a first side of a covering member, positioning the object on a second side of the covering member, coupling measurement circuitry to the plurality of sensing coils, configuring the measurement circuitry to measure a change of inductance of said sensing coils, said change of inductance caused by an interfering member adjacent to the object, said interfering member having an interfering magnetic field, and wherein the method further comprises the steps of configuring said interfering member to affect at least one of the plurality of sensing coils along the sensing axis at any given position along the sensing axis, and configuring the measurement circuitry to determine the position of the object along the sensing axis based on the inductance change caused by the interfering magnetic field of the interfering member as part of the object.

16. The method of claim 15, wherein the object is a liquid float, and wherein the covering member is a sealed enclosure, the method further comprising the steps of using the sensing system to determine the level of a liquid in a container by measuring the position of the interfering member attached to the liquid float.

17. The method of claim 15, further comprising the step of configuring the measurement circuitry to apply an excitation signal at a predetermined frequency to said plurality of sensing coils, and wherein the interfering member is a passive resonant circuit which comprises an interfering coil and a capacitor, the passive resonant circuit having a resonant frequency that is equal to or substantially equal to the predetermined frequency of the excitation signal, and wherein the interfering magnetic field is the magnetic field induced in the interfering coil in response to at least one of the plurality of sensing coils.

18. The method of claim 15, wherein the interfering member is a polarized magnet, the method comprising the step of positioning a magnetically permeable layer adjacent to the plurality of sensing coils to enhance the inductance of said plurality of sensing coils, and wherein the interfering magnetic field is the magnetic field of the polarized magnet, and wherein the change of inductance is due to the magnetic field of the polarized magnet changing the material properties of the magnetically permeable layer.

19. The method of claim 15, further comprising the step of configuring the interfering member to affect at least two of the plurality of sensing coils along the sensing axis at any given position along the sensing axis.

20. The method of claim 15, the method further comprising the step of providing user feedback regarding the level, turbulence or leakage status of the container based on the sensing coil measurements by means of a user interface device that is connected to the measurement circuitry.
